(19) United States
(12) Patent Application Publication
(10) Pub. No.: US 2026/0126548 A1
(43) Pub. Date: May 7, 2026

(54) DISTANCE MEASUREMENT SYSTEMS AND METHODS

(71) Applicant: AzerGrade Innovations Inc, Whitesburg, GA (US)

(72) Inventor: Richard Strickland, JR., Whitesburg, GA (US)

(73) Assignee: AzerGrade Innovations Inc, Whitesburg, GA (US)

(21) Appl. No.: 18/939,654

(22) Filed: Nov. 7, 2024

(51) Int. Cl. G01S 17/08; G01C 5/06; G01S 7/00; G01S 7/497; G01S 7/51; G01S 17/88

(52) U.S. Cl. CPC G01S 17/08; G01C 5/06; G01S 7/003; G01S 7/497; G01S 7/51; G01S 17/88

(57) ABSTRACT

A system including a laser reading unit and a laser distance measuring unit is disclosed. The laser reading unit may be mounted on a device body associated with a device. The laser reading unit may read a laser signal projected by a laser projecting unit to establish a reference point. The reference point is a point at which the laser reading unit reads the laser signal projected by the laser projecting unit. The laser distance measuring unit may also be mounted on the device body. The laser distance measuring unit may measure a vertical distance between the reference point and ground.

### TECHNICAL FIELD

The present disclosure relates to distance measurement systems and methods for measuring distance from ground surface.

### BACKGROUND

In the construction industry, it is crucial to measure trench excavation accurately (including the trench depth). A precise measurement ensures proper planning, effective utilization of resources, and a high standard of safety.

There exist different ways to measure trench depths. For instance, some operators use laser projectors and grade sticks (or grade rods) for establishing grades and reference points, which may enable the operator to measure the trench depth. The operator may position the laser projector and the grade stick in proximity to the excavator while performing the excavation operation. The laser projector may project a laser signal over a 360 degrees range along a horizontal axis of the laser projector. The grade stick may include a sliding laser reader that may read the laser signal projected by the laser projector to establish the reference point. The grade stick may include measuring scale markings along its length, which may enable the operator to measure the trench depth from the reference point.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example first device for enabling distance measurement from ground in accordance with the present disclosure.

FIG. 2 depicts a view of an arm of the first device of FIG. 1 having a laser reading unit and a laser distance measuring unit in accordance with the present disclosure.

FIG. 3 depicts an example second device for enabling distance measurement from ground in accordance with the present disclosure.

FIG. 4 depicts an example third device for enabling distance measurement from ground in accordance with the present disclosure.

FIG. 5 depicts a flow diagram of an example method to measure distance from ground, in accordance with the present disclosure.

### DETAILED DESCRIPTION

### Overview

The present disclosure is directed to a distance measuring system (“system”) that be mounted or connected to a device, and confirmed to determine a distance between a device component and the ground relative to a reference point. In some aspects, the device may be construction equipment (e.g., an excavator or a backhoe). In this case, the system may assist an equipment operator to determine a distance between an equipment component relative to the ground, to precisely perform excavation to a required depth. The construction equipment may include a plurality of components including, but not limited to, an implement (e.g., a blade or a bucket that contacts the ground), an arm, a boom, an operator cabin, tracks, etc. The arm may be located between the implement and the boom, and the boom may be attached to the cabin. The operator may use a control panel located inside the cabin to move the arm vertically upwards or downwards (e.g., away from or towards the ground).

The system may include a combination of a laser level and a laser distance measuring unit. The laser level may include a laser projecting unit or a laser transmitting unit that may project a first laser signal (e.g., a continuous laser beam) over a 360 degrees range along a horizontal axis of the laser projecting unit. The laser level may further include a laser reading unit that may read or pick up the first laser signal projected by the laser projecting unit. The laser reading unit may be attached to the construction equipment body. In some aspects, the laser reading unit may be removably attached to the arm of the construction equipment via a magnet. The laser projecting unit may be positioned on the ground, in proximity to the construction equipment.

In some aspects, when the laser projecting unit is projecting the first laser signal, the operator may use the control panel located inside the cabin to move the arm vertically upwards or downwards. The arm movement may cause the vertical movement of the laser reading unit, which may enable the laser reading unit to read the first laser signal projected by the laser projecting unit. When the laser reading unit reads the first laser signal, the laser level may establish a reference point, which may enable the operator to ensure accuracy in leveling and alignment. In addition, the reference point may enable the operator to set and maintain a required depth for excavation, thereby ensuring that the ground is excavated evenly. In further aspects, the laser reading unit may generate an indication (e.g., an indication signal) when the laser reading unit reads the first laser signal or when the reference point is established. In some aspects, the laser reading unit may provide the indication (e.g., audio or visual indication) to the operator when the laser reading unit reads the first laser signal. Alternatively, the laser reading unit may transmit the indication signal to a controller associated with the system.

The laser distance measuring unit may be connected to the construction equipment. In some aspects, the laser distance measuring unit may be disposed in proximity to the laser reading unit such that the laser distance measuring unit and the laser reading unit may be equidistant from the ground. The laser distance measuring unit may measure a vertical distance between the reference point (established using the laser level) and the ground, which may assist the operator to precisely perform excavation to the required depth.

In some aspects, the controller may trigger or activate the laser distance measuring unit to measure the vertical distance when the controller obtains the indication associated with the reference point from the laser reading unit. Since the laser distance measuring unit and the laser reading unit are located in proximity to each other and at the same distance from the ground, the controller may activate or trigger the laser distance measuring unit when the laser reading unit reads the laser signal projected by the laser projecting unit, to measure the distance between the reference point and the ground. Alternatively, the operator may trigger or activate the laser distance measuring unit when the operator obtains the indication associated with the reference point from the laser reading unit.

When the laser distance measuring unit obtains the trigger signal, the laser distance measuring unit may project a second laser signal towards the ground. When the laser distance measuring unit projects the second laser signal, the second laser signal may get reflected from the ground. The laser distance measuring unit may receive or read the reflected laser signal from the ground (via a reader or receiver). When the laser distance measuring unit receives the reflected laser signal, the laser distance measuring unit (e.g., a controller associated with the laser distance measuring unit) may determine a time-of-flight or time taken by the second laser signal to hit the ground and for the reflected laser signal to reach the laser distance measuring unit. The laser distance measuring unit may then determine the vertical distance between the reference point and the ground based on the time-of-flight.

In some aspects, the controller may transmit information associated with the measured vertical distance to a user device (e.g., a mobile phone, a desktop computer, a laptop, a tablet, a smartwatch, etc.), via a network. The operator may view the measured vertical distance on a user interface associated with the user device and may decide how deep the implement should be while performing the digging operation.

In further aspects, the device may be a drone. In this case, the system may assist a drone operator to use the drone for surveillance of a geographical area (e.g., for 3D mapping of the geographical area). The system may further be mounted on other devices such as a computer numerical control (CNC) machine, to manufacture high-precision parts.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

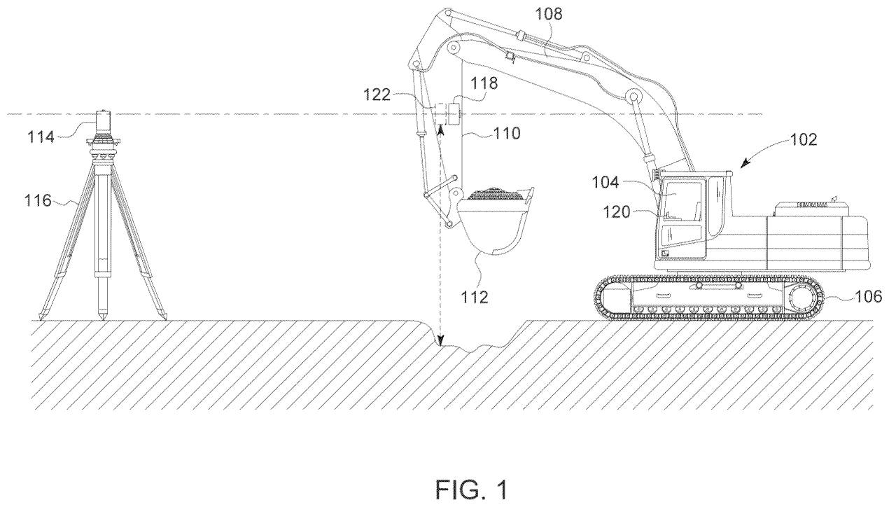

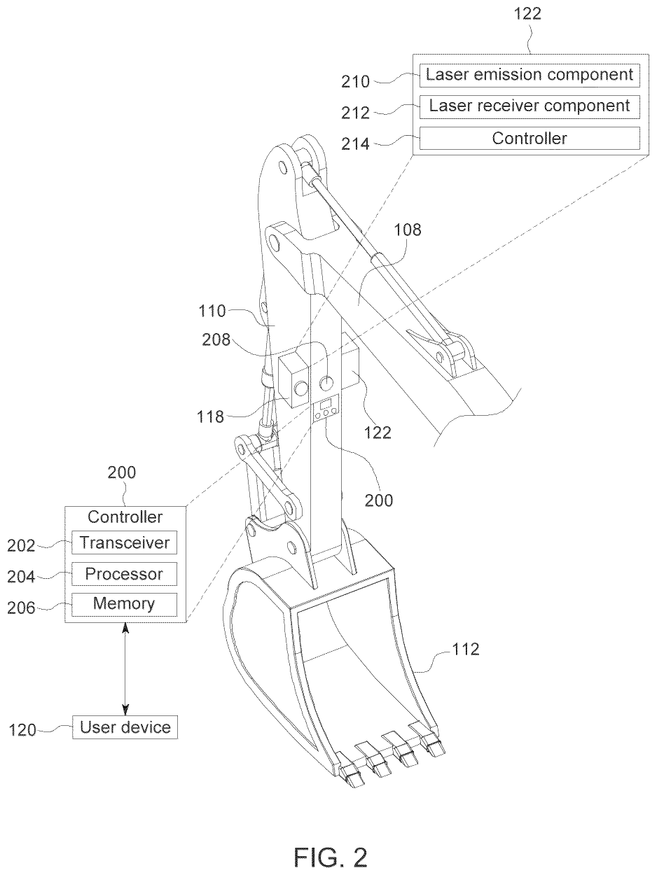

FIG. 1 depicts an example first device 102 for enabling distance measurement from ground in accordance with the present disclosure. FIG. 1 will be described in conjunction with FIG. 2.

In some aspects, the first device 102 may be a construction equipment. Hereinafter, the first device 102 is referred to as construction equipment 102. The construction equipment 102 may be, for example, an excavator, a backhoe, and/or the like, which an operator may use to perform digging operations. The construction equipment 102 may include a plurality of components including, but not limited to, a cabin 104, tracks 106, a boom 108, an arm 110, and an implement 112. The cabin 104 may be an operator's cabin. The operator may sit inside the cabin 104 and operate the construction equipment 102. In some aspects, the cabin 104 may be rotating cabin that may rotate 360 degrees. The cabin 104 may include a control panel (not shown) that may enable the operator to operate the construction equipment 102. The control panel may include joysticks and other components that the operator may use to operate the construction equipment 102.

The tracks 106 may be rubber or steel tracks that may enable the construction equipment 102 to move (e.g., from a first location to a second location). The boom 108 may be a horizontal structure that extends outward from the excavator's chassis. The boom 108 may be disposed parallel or substantially parallel to the ground surface when the operator operates the construction equipment 102 for the digging operations. The arm 110 may be connected to an end (e.g., a distal end) of the boom 108 and may extend downward towards the ground surface. One end of the arm 110 (e.g., an arm proximal end) may be connected to the boom 108 and another end (e.g., an arm distal end) may be connected to the implement 112. The implement 112 may be a bucket or a blade, which may be used for digging and collecting soil, debris, etc. during the digging operations. The implement 112 may be of any size and type based on the digging operation requirements.

The present disclosure further discloses a distance measuring system (or system) that may include a laser level (e.g., a rotary laser level) that the operator may use to produce a highly accurate horizontal levelling line. The operator may use the laser level for establishing grades and reference points (e.g., a horizontal reference point) across a surface, which may enable the operator to ensure accuracy in leveling and alignment. The reference point may provide a reference for leveling and alignment. The reference point may enable the operator to set and maintain a required depth for excavation, thereby ensuring that the ground is excavated evenly.

The laser level may include a laser projecting unit 114 that may project/transmit a laser signal/beam (or a first laser signal) over a 360 degrees range along a horizontal axis of the laser projecting unit 114. The horizontal axis, as described in the present disclosure, may mean an axis that is parallel to the ground surface. The laser projecting unit 114 may be mounted on a tripod 116 (or any other similar structure) at a predetermined height from the ground. The laser projecting unit 114 may transmit or project a continuous laser beam in a horizontal plane parallel to the ground surface. Alternatively, the laser projecting unit 114 may project laser light flashes in a single or multiple directions.

The laser level may further include a laser reading unit 118 (shown in FIGS. 1 and 2) that may read the laser signal projected by the laser projecting unit 114, to establish the reference point. The laser reading unit 118 may pick/receive the laser signal transmitted by the laser projecting unit 114 when the laser reading unit 118 may be horizontally aligned with the laser projecting unit 114. The reference point may be a point at which the laser reading unit 118 reads the laser signal projected by the laser projecting unit 114, which may act as the reference for leveling and alignment. In some aspects, the laser reading unit 118 may include a photosensor that may detect the laser signal or the laser beam projected by the laser projecting unit 114, when the laser reading unit 118 intercepts the laser signal or the laser beam projected by the laser projecting unit 114.

In some aspects, the laser reading unit 118 may be mounted on construction equipment body (or first device body) such as the arm 110 or any other construction equipment component, which may move vertically up and down, e.g., towards the ground or away from the ground. In some aspects, the laser reading unit 118 may be removably mounted on the arm 110 by using a first magnet (not shown). Stated another way, the laser reading unit 118 may be magnetically coupled with the metallic body of the arm 110. In other aspects, the laser reading unit 118 may be removably mounted on the arm 110 by using one or more fasteners (e.g., screws, nuts, bolts, etc.).

The laser projecting unit 114 may be positioned on the ground, in proximity to the construction equipment 102. Stated another way, the laser projecting unit 114 may not be a part of the construction equipment 102. The reference point may be established when the laser reading unit 118 reads the laser signal projected by the laser projecting unit 114. In some aspects, the reference point may be established when the operator moves the arm 110 vertically up or down and when the laser reading unit 118 gets horizontally aligned with the laser projecting unit 114.

In operation, when the laser projecting unit 114 is projecting the laser signal, the operator may use the control panel located inside the cabin 104 to move the arm 110 vertically upwards or downwards relative to the ground surface. The arm movement may cause vertical movement of the laser reading unit 118 (since the laser reading unit 118 is mounted on the arm 110, as described above), which may enable the laser reading unit 118 to read the laser signal projected by the laser projecting unit 114. When the laser reading unit 118 reads the laser signal, the laser level may establish the reference point.

In some aspects, when the laser reading unit 118 reads the laser signal, the laser reading unit 118 may generate and provide an indication to the operator. In some aspects, the laser reading unit 118 may provide a visual indication to the operator (e.g., via a light emitting device included in the laser reading unit 118). In further aspects, the laser reading unit 118 may provide an audio indication to the operator (e.g., via a buzzer or a speaker included in the laser reading unit 118). Such indicators may enable the operator to determine that the reference point is established.

In further aspects, the laser reading unit 118 may communicatively couple with a controller 200 (e.g., a first controller 200, shown in FIG. 2), and may transmit the indication (as a command signal) associated with the reference point to the controller 200. In some aspects, the laser reading unit 118 may communicatively couple with the controller 200 through wires. Alternatively, the laser reading unit 118 may communicatively couple with the controller 200 via a network (not shown). In further aspects, the laser reading unit 118 may communicatively couple with a user device 120, associated with the operator, via the network. The user device 120 may be, for example, a mobile phone, a desktop computer, a laptop, a tablet, a smartwatch, or any other device with communication capabilities. In some aspects, the operator may access the user device 120 to view information associated with the reference point. In some aspects, the user device 120 may be disposed in the cabin 104. Alternatively, the user device 120 may be disposed outside the cabin 104.

The network, as described herein, illustrates an example communication infrastructure in which the connected devices discussed in various embodiments of this disclosure may communicate. The network may be and/or include the Internet, a private network, public network or other configuration that operates using any one or more known communication protocols such as transmission control protocol/Internet protocol (TCP/IP), Bluetooth^{®}, Bluetooth^{®}Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The controller 200 may include a plurality of components/units including, but not limited to, a transceiver 202, a processor 204 and a memory 206, which are communicatively coupled with each other. The transceiver 202 may receive information associated with the reference point from the laser reading unit 118. In addition, the transceiver 202 may receive information associated with a first vertical distance (measured by a laser distance measuring unit 122) and a second vertical distance (measured by an atmospheric pressure sensor 208), as described later in the present disclosure. The transceiver 202 may transmit the information associated with the reference point, the first vertical distance and the second vertical distance to the user device 120. The memory 206 may store the reference point measured by the laser reading unit 118. In addition, the memory 206 may store the information associated with the reference point, the first vertical distance and the second vertical distance.

The processor 204 may utilize the memory 206 to store programs in code and/or to store data for performing aspects in accordance with the disclosure. The memory 206 may be a non-transitory computer-readable storage medium or memory storing a program code that enables the processor 204 to perform operations in accordance with the present disclosure. The memory 206 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In some aspects, in addition to the laser reading unit 118, a laser distance measuring unit 122 (part of the system) may also be mounted on the construction equipment body (or first device body) such as the arm 110 or any other construction equipment component. The laser distance measuring unit 122 may measure a first vertical distance between the reference point (established using the laser level) and the ground surface. In some aspects, the laser distance measuring unit 122 may be removably mounted on the arm 110 by using a second magnet (not shown). In some aspects, the laser distance measuring unit 122 may be disposed in proximity to the laser reading unit 118. Further, the laser reading unit 118 and the laser distance measuring unit 122 may be disposed equidistant from the ground. In some aspects, the laser distance measuring unit 122 and the laser reading unit 118 may be mounted to the arm 110 via a single connector to facilitate the alignment between the laser distance measuring unit 122 and the laser reading unit 118. Specifically, the laser distance measuring unit 122 and the laser reading unit 118 may be mounted to the arm 110 via a single connector to ensure that both the laser distance measuring unit 122 and the laser reading unit 118 are always equidistant from the ground surface (irrespective of the position of the arm 110 relative to the ground surface). In other aspects, the laser distance measuring unit 122 and the laser reading unit 118 may be part of a single electronic unit that may be mounted on the arm 110.

The laser distance measuring unit 122 may include a plurality of components including, but not limited to, a laser emission component 210, a laser receiver component 212, and a controller 214 (e.g., a second controller 214). The laser emission component 210 may project a second laser signal/beam towards the ground surface to measure the first vertical distance between the reference point and the ground. In some aspects, the laser emission component 210 may project the second laser signal when the laser emission component 210 may be activated or triggered.

In further aspects, the laser emission component 210 may face towards the ground when the laser distance measuring unit 122 may be mounted on the arm 110, and may project the second laser signal towards the ground. When the laser emission component 210 projects the second laser signal, the second laser signal may get reflected from the ground surface. The laser receiver component 212 may receive or read the reflected laser signal from the ground responsive to projecting the second laser signal. When the laser receiver component 212 receives the reflected laser signal, the controller 214 may determine a time-of-flight associated the second laser signal and the reflected laser signal. Stated another way, the controller 214 may determine the time taken by the second laser signal to hit the ground and for the reflected laser signal to reach to the laser receiver component 212 (or the laser distance measuring unit 122). The controller 214 may then determine the first vertical distance between the reference point and the ground, based on the time-of-flight. In some aspects, the laser emission component 210 may project the second laser signal to the ground when the laser reading unit 118 reads the first laser signal projected by the laser projecting unit 114 (and hence when the reference point is established; specifically, at the same time when the reference point is established by the laser reading unit 118). Therefore, by using the time-of-flight information associated with the second laser signal (as described above) when the reference point is established by the laser reading unit 118, the controller 214 may efficiently determine the first vertical distance between the reference point and the ground.

The laser distance measuring unit 122 may communicatively couple with the controller 200 (or the first controller) and/or the user device 120 via the network. The laser distance measuring unit 122 may transmit information associated with the first vertical distance to the controller 200 (e.g., via the transceiver 202) and/or the user device 120. In some aspects, the laser distance measuring unit 122 may directly transmit the information associated with the first vertical distance to the user device 120. Alternatively, the laser distance measuring unit 122 may transmit the information associated with the first vertical distance to the user device 120 via the controller 200 (e.g., via the transceiver 202). In this case, the transceiver 202 may receive the information associated with the first vertical distance from the laser distance measuring unit 122, and transmit the information to the user device 120. In some aspects, the controller 200 may save the information associated with the first vertical distance in the memory 206, when the transceiver 202 receives the information associated with the first vertical distance from the laser distance measuring unit 122.

The operator may view the information associated with the first vertical distance (between the reference point and the ground) on a user interface associated with the user device 120, which may enable the operator to maintain the required excavation depth.

In some aspects, the processor 204 associated with the controller 200 may transmit a command signal to activate or trigger the laser emission component 210 when the laser emission component 210 (or the laser distance measuring unit 122) may be located at the reference point. Since the laser distance measuring unit 122 and the laser reading unit 118 are located in proximity to each other (and at a same distance from the ground), the operator or the processor 204 may activate or trigger the laser emission component 210 when the laser reading unit 118 reads the laser signal projected by the laser projecting unit 114. Specifically, the processor 204 may obtain the information associated with the reference point from the laser reading unit 118 (via the transceiver 202) when the laser reading unit 118 reads the first laser signal. Responsive to obtaining the information associated with the reference point, the processor 204 may transmit the command signal to the laser distance measuring unit 122 to trigger or activate the laser distance measuring unit 122 (or the laser emission component 210). When the processor 204 triggers the laser distance measuring unit 122, the laser distance measuring unit 122 may measure the first vertical distance and may transmit information associated with the measured first vertical distance to the transceiver 202. The processor 204 may then obtain the information associated with the first vertical distance from the transceiver 202 (e.g., responsive to triggering the laser distance measuring unit 122). The processor 204 may then transmit the information associated with the first vertical distance to the user device 120. The operator may then view the first vertical distance on the user interface associated with the user device 120.

In further aspects, the processor 204 may calibrate the laser distance measuring unit 122 responsive to obtaining the information associated with the reference point (or whenever the laser distance measuring unit 122 crosses the reference point). Once the laser distance measuring unit 122 is calibrated at the reference point, the laser distance measuring unit 122 may measure / display the first vertical distance from the reference point (at which the laser distance measuring unit 122 may be located) to the ground, to determine the depth for excavation.

In other aspects, instead of the processor 204 activating the laser emission component 210, the operator may activate or trigger the laser emission component 210 when the laser emission component 210 (or the laser distance measuring unit 122) may be located at the reference point. For instance, the operator may trigger the laser emission component 210 (or the laser distance measuring unit 122) when the operator receives audio or visual indication from the laser reading unit 118 regarding the reference point. In addition, the operator may use the user device 120 to calibrate the laser distance measuring unit 122 when the laser distance measuring unit 122 may be at the reference point (or when the laser reading unit 118 detects/reads the first laser signal). Once the laser distance measuring unit 122 is calibrated at the reference point, the laser distance measuring unit 122 may measure/display the first vertical distance on the user device 120. For example, when the operator activates the laser distance measuring unit 122, the user device 120 may display “5 feet” distance to the ground. In this manner, the operator may view the reading on the user device 120, and may accurately or precisely perform the digging operation to the required depth.

In additional aspects, the controller 200 may receive a required trench depth from the operator, correlate the required trench depth with the measured first vertical distance, and provide instructions to the operator to move the implement 112 such that the implement 112 (or the construction equipment 102) digs the trench to the required depth. In alternative aspects, the controller 200 may automatically control the implement movement based on the required trench depth relative to the measured first vertical distance, to precisely perform the digging operation. In further aspects, the controller 200 may include an Artificial Intelligence (AI) based agent that may assist the operator to move the implement 112 to the required depth (or to perform other tasks based on the operator inputs). In some aspects, the controller 200 may receive the operator inputs in audio format (e.g., in natural language), and may perform the respective task associated with the operator inputs (e.g., control implement movement to perform excavation to the required depth). In some aspects, the controller 200 may include a microphone to receive the audio inputs/instructions from the operator. In addition, the controller 200 may include a speaker to provide instructions to the operator. Furthermore, the construction equipment 102 may include a video camera (not shown) configured to capture images surrounding the construction equipment 102. The controller 200 may communicatively couple with the video camera. The controller 200 may receive inputs from the video camera, and may perform the required tasks (automatically or based on the operator inputs) based on the inputs obtained from the video camera.

In further aspects, an atmospheric pressure sensor 208 (as shown in FIG. 2) may be disposed on the construction equipment 102 (or the first device body), e.g., on the arm 110 or any other construction equipment component. The atmospheric pressure sensor 208 may measure a second vertical distance between the reference point and the ground (e.g., by measuring change in atmospheric pressure). The atmospheric pressure sensor 208 may detect the second vertical distance between the reference point and the ground based on the atmospheric pressure detected by the atmospheric pressure sensor 208. In some aspects, the atmospheric pressure sensor 208 may be disposed in proximity to the laser reading unit 118 and the laser distance measuring unit 122. Further, the atmospheric pressure sensor 208, the laser reading unit 118, and the laser distance measuring unit 122 may be disposed equidistant from the ground.

The atmospheric pressure sensor 208 may communicatively couple with the controller 200. In some aspects, the controller 200 may transmit another command signal to the atmospheric pressure sensor 208 responsive to obtaining the information associated with the reference point. The atmospheric pressure sensor 208 may measure the second vertical distance responsive to receiving the command signal from the controller 200, and transmit the information associated with the second vertical distance to the controller 200. The controller 200 may receive the information associated with the second vertical distance from the atmospheric pressure sensor 208, and correlate the second vertical distance with the first vertical distance measured by the laser distance measuring unit 122. The controller 200 may then determine a final vertical distance between the reference point and the ground based on the correlation. In some aspects, the controller 200 may determine an average of the second vertical distance and the first vertical distance to determine the final vertical distance. The controller 200 may transmit the final vertical distance to the user device 120. The atmospheric pressure sensor 208 may enable the controller 200 to fine tune the first vertical distance measured by the laser distance measuring unit 122, thereby enabling the controller 200 to accurately determine the distance between the reference point and the ground, which may help the operator to decide how deep the implement 112 should be while performing the digging operation. In other aspects, when the controller 200 obtains either the first vertical distance from the laser distance measuring unit 122 or the second vertical distance from the atmospheric pressure sensor 208, the controller 200 may transmit either the first vertical distance or the second vertical distance to the user device 120.

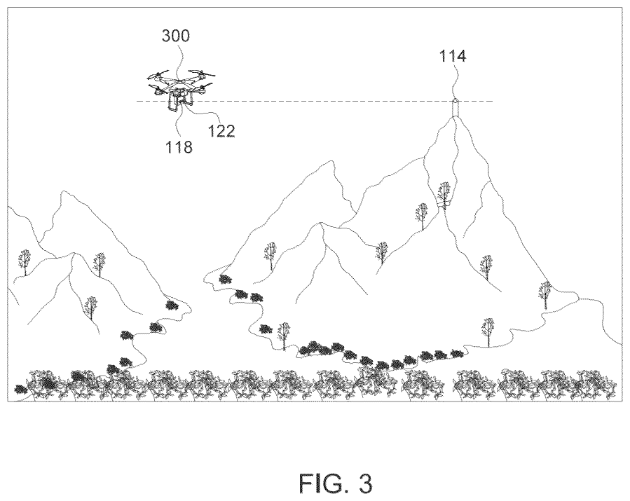

FIG. 3 depicts an example second device for enabling distance measurement from ground in accordance with the present disclosure. The second device may be an aerial vehicle such as an unmanned aerial vehicle (UAV) or drone 300 (as shown in FIG. 3) that may include the same laser reading unit 118 and laser distance measuring unit 122 described above. Stated another way, in this aspect, the laser reading unit 118 and the laser distance measuring unit 122 may be disposed on an aerial vehicle, instead of a construction equipment as described above in conjunction with FIGS. 1 and 2.

An operator may use the drone 300 for different purposes including, but not limited to, surveillance, military operations, etc. Specifically, a drone operator may use the drone 300 to monitor or determine characteristics of a geographical area over which the operator may cause the drone 300 to fly. As described above, the drone 300 may include the laser reading unit 118 and the laser distance measuring unit 122, which may enable the drone operator to perform surveillance. For instance, the drone operator may use the drone 300 to perform 3D mapping of the geographical area over which the drone 300 may be flying. The laser reading unit 118 and the laser distance measuring unit 122 may be aligned with each other (in the same manner as described above) when the laser reading unit 118 and the laser distance measuring unit 122 may be attached to the drone 300.

In some aspects, in this case, the laser projecting unit 114 may be mounted or positioned anywhere in the geographical area. The laser projecting unit 114 may be positioned on the ground (e.g., on mountains) or at a predetermined distance from the ground (e.g., using a tower). As described above, the laser projecting unit 114 may project the laser signal or laser beam over a 360 degrees range. The laser reading unit 118, which may be mounted on the drone 300, may read the laser signal projected by the laser projecting unit 114 to establish the reference point, when the drone 300 may be horizontally aligned with the laser projecting unit 114. When the laser reading unit 118 establishes the reference point, the laser reading unit 118 may transmit an indication signal to the drone operator or a drone controller (not shown), via the network described above.

The drone 300 may further include the laser distance measuring unit 122 that may measure a vertical distance between the reference point (established by using the laser level) and the ground. The laser distance measuring unit 122 may measure the vertical distance when the laser distance measuring unit 122 may be triggered or activated. In some aspects, the drone operator or the drone controller may activate the laser distance measuring unit 122 when the laser reading unit 118 provides the indication associated with the reference point. Responsive to activating the laser distance measuring unit 122, the laser distance measuring unit 122 may measure the vertical distance in the same manner as described above in conjunction with FIGS. 1 and 2. Responsive to measuring the vertical distance, the laser distance measuring unit 122 may transmit the information associated with the vertical distance to the drone controller or the drone operator. In some aspects, the drone 300 may store the vertical distance in a memory associated with the drone controller, and may use the stored information for 3D mapping of the geographical area.

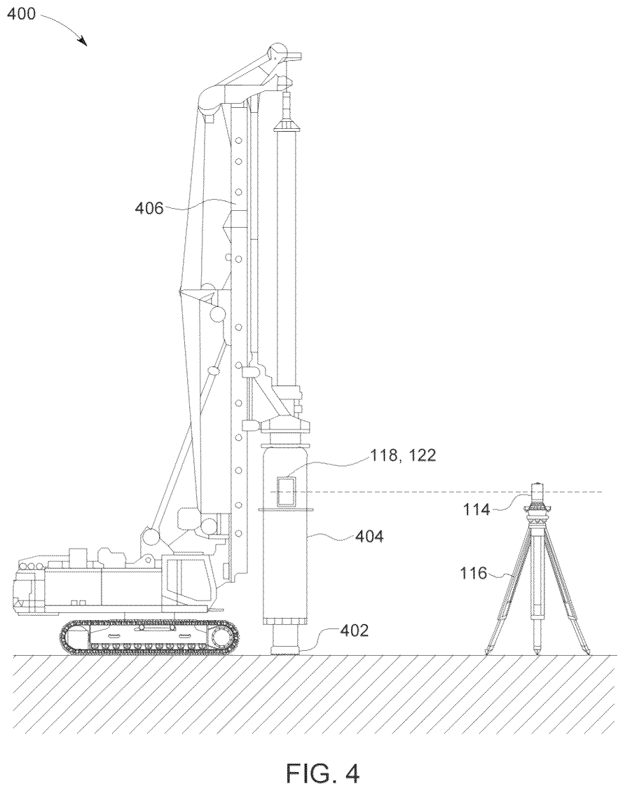

FIG. 4 depicts an example third device for enabling distance measurement from ground in accordance with the present disclosure. The third device may be a drilling equipment 400. The drilling equipment 400 may be used for drilling holes in the ground (or rock) with great accuracy for mining, quarrying, and construction. The operator may use the drilling equipment 400 to drill the holes vertically in the ground (e.g., perpendicular to the ground) or horizontally in the rock (e.g., parallel to the ground). For instance, the drilling equipment 400 may be used to build a tunnel. The drilling equipment 400 may drill holes in the rock to position explosives in the holes for blasting.

The drilling equipment 400 may include a plurality of components including, but not limited to, a drill bit 402 (that penetrates through the ground/rock), a hammer body 404 (that generates impact force on the drill bit 402), a mast 406 (vertical structure that supports drilling apparatus), a drive mechanism (that powers the rotation of the drill bit 402 while the hammer body 404 delivers the impact), a power source, and/or the like. The drilling equipment 400 may be operated by air or gas under pressure (e.g., compressed air).

The drilling equipment 400 may include the laser reading unit 118 and the laser distance measuring unit 122, which may enable the operator to perform the drilling to a required depth. The laser reading unit 118 and the laser distance measuring unit 122 may be mounted on the drilling equipment 400. In some aspects, the laser reading unit 118 and the laser distance measuring unit 122 may be mounted on the hammer body 404 (in the same manner as described above for the construction equipment 102).

In some aspects, in this case, the laser projecting unit 114 may be mounted or positioned anywhere in the geographical area where the drilling equipment 400 is located. The laser projecting unit 114 may be positioned on the ground (e.g., on mountains) or at a predetermined distance from the ground (e.g., using a tower). In other aspects, the laser projecting unit 114 may be mounted on the mast 406. As described above, the laser projecting unit 114 may project the laser signal or laser beam over a 360 degrees range.

The laser reading unit 118, which may be mounted on the hammer body 404, may read the laser signal projected by the laser projecting unit 114 to establish the reference point, when the hammer body 404 moves up and down. The laser reading unit 118 may be horizontally aligned with the laser projecting unit 114. When the laser reading unit 118 establishes the reference point, the laser reading unit 118 may transmit an indication signal to the operator or the controller 200 as described above.

The drilling equipment 400 may further include the laser distance measuring unit 122 that may measure a vertical distance between the reference point (established by using the laser level) and the ground. The laser distance measuring unit 122 may measure the vertical distance when the laser distance measuring unit 122 may be triggered or activated. In some aspects, the operator or the controller 200 may activate the laser distance measuring unit 122 when the laser reading unit 118 provides the indication associated with the reference point. Responsive to activating the laser distance measuring unit 122, the laser distance measuring unit 122 may measure the vertical distance in the same manner as described above in conjunction with FIGS. 1 and 2.

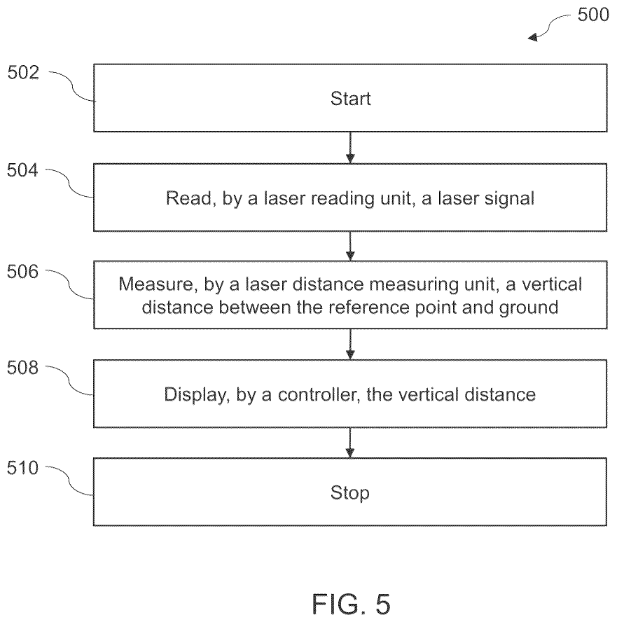

FIG. 5 depicts a flow diagram of an example method 500 to measure distance from ground, in accordance with the present disclosure. FIG. 5 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 500 starts at step 502. At step 504, the method 500 includes reading, by the laser reading unit 118, the laser signal projected by the laser projecting unit 114 to establish the reference point. As described above, the reference point may be established when the laser reading unit 118 reads the laser signal projected by the laser projecting unit 114. In some aspects, the reference point may be established when the operator moves the arm 110 vertically and when the laser reading unit 118 is horizontally aligned with the laser projecting unit 114.

At step 506, the method 500 may include measuring, by the laser distance measuring unit 122, the first vertical distance between the reference point and the ground. In some aspects, the controller 200 (e.g., the processor 204) may obtain the indication of the reference point from the laser reading unit 118, and may trigger or activate the laser distance measuring unit 122 to measure the first vertical distance between the reference point and the ground (by projecting the second laser signal to the ground) responsive to obtaining the indication of the reference point. The laser distance measuring unit 122 may measure the first vertical distance when the laser distance measuring unit 122 is triggered or activated.

At step 508, the method 500 may further include causing, by the controller 200 (e.g., the processor 204), to display the first vertical distance on the user interface associated with the user device 120. The operator may view the first vertical distance and may accordingly perform the digging operation (e.g., dig the trench to the required depth).

The method 500 stops at step 510.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system comprising:
a laser reading unit mounted on a device body associated with a device, wherein the laser reading unit is configured to read a first laser signal projected by a laser projecting unit to establish a reference point, and wherein the reference point is a point at which the laser reading unit reads the first laser signal projected by the laser projecting unit; and
a laser distance measuring unit mounted on the device body, wherein the laser distance measuring unit is configured to measure a first vertical distance between the reference point and ground.

2. The system of claim 1, wherein the device is a construction equipment.

3. The system of claim 2, wherein the laser reading unit and the laser distance measuring unit are mounted on an arm of the construction equipment.

4. The system of claim 1, wherein the device is an aerial vehicle.

5. The system of claim 1 further comprising a transceiver configured to receive an information associated with the reference point from the laser reading unit and an information associated with the first vertical distance from the laser distance measuring unit.

6. The system of claim 5, wherein the transceiver is further configured to transmit the information associated with the first vertical distance to a user device.

7. The system of claim 6 further comprising a processor configured to:
obtain the information associated with the reference point from the transceiver;
transmit a command signal to the laser distance measuring unit to trigger the laser distance measuring unit, responsive to obtaining the information associated with the reference point;
obtain the information associated with the first vertical distance from the laser distance measuring unit responsive to triggering the laser distance measuring unit; and
transmit the information associated with the first vertical distance to the user device via the transceiver, wherein the user device is configured to display the first vertical distance on a user interface of the user device.

8. The system of claim 7, wherein the processor is further configured to calibrate the laser distance measuring unit responsive to obtaining the information associated with the reference point.

9. The system of claim 7 further comprising an atmospheric pressure sensor configured to measure a second vertical distance between the reference point and ground, responsive to receiving another command signal from the processor.

10. The system of claim 9, wherein the processor is further configured to:
correlate the second vertical distance and the first vertical distance; and
determine a final vertical distance between the reference point and the ground based on the correlation.

11. The system of claim 1, wherein the laser projecting unit is configured to project the first laser signal over a 360 degrees range along a horizontal axis of the laser projecting unit, and wherein the horizontal axis is parallel to ground.

12. The system of claim 1, wherein the laser reading unit and the laser distance measuring unit are removably mounted on the device.

13. The system of claim 1, wherein the laser distance measuring unit comprises:
a laser emission component configured to project a second laser signal to the ground;
a laser receiver component configured to read a reflected laser signal from the ground responsive to projecting the second laser signal; and
a controller configured to measure the first vertical distance based on time-of flight associated with the second laser signal and the reflected laser signal.

14. The system of claim 1, wherein the laser reading unit is disposed in proximity with the laser distance measuring unit.

15. The system of claim 1, wherein the laser reading unit and the laser measuring unit are disposed equidistant from the ground.

16. The system of claim 1, wherein the laser projecting unit is positioned at a predetermined height from the ground.

17. A system comprising:
a laser reading unit mounted on a device body associated with a device, wherein the laser reading unit is configured to read a laser signal projected by a laser projecting unit to establish a reference point, and wherein the reference point is a point at which the laser reading unit reads the laser signal projected by the laser projecting unit; and
a laser distance measuring unit mounted on the device body, wherein the laser distance measuring unit is configured to measure a vertical distance between the reference point and ground,
wherein the laser reading unit and the laser distance measuring unit are mounted on an arm of a construction equipment.

18. The system of claim 17 further comprising a transceiver configured to:
receive an information associated with the reference point from the laser reading unit and an information associated with the vertical distance from the laser distance measuring unit; and
transmit the information associated with the vertical distance to a user device.

19. The system of claim 18 further comprising a processor configured to:
obtain the information associated with the reference point from the transceiver;
transmit a command signal to the laser distance measuring unit to trigger the laser distance measuring unit, responsive to obtaining the information associated with the reference point;
obtain the information associated with the vertical distance from the laser distance measuring unit responsive to triggering the laser distance measuring unit; and
transmit the information associated with the vertical distance to the user device via the transceiver, wherein the user device is configured to display the vertical distance on a user interface of the user device.

20. A method comprising:
reading, by a laser reading unit, a laser signal projected by a laser projecting unit, wherein the laser reading unit is removably mounted on a device body associated with a device, wherein the laser reading unit is configured to read the laser signal projected by the laser projecting unit to establish a reference point, and wherein the reference point is a point at which the laser reading unit reads the laser signal projected by the laser projecting unit;
measuring, by a laser distance measuring unit, a vertical distance between the reference point and ground; and
causing to display, by a controller, the vertical distance on a user interface of a user device.
